(19) United States
(12) Patent Application Publication
(10) Pub. No.: US 2011/0170185 A1
(43) Pub. Date: Jul. 14, 2011

(54) Three-dimensional glasses and three-dimensional display apparatus

(75) Inventors: Hoon Song, Yongin-si (KR); Yong-kweun Mun, Yongin-si (KR); Yoon-sun Choi, Yongin-si (KR); Hong-seok Lee, Seongnam-si (KR); Hyung-sok Yeo, Hwaseong-si (KR)

(73) Assignee: Samsung Electronics Co., Ltd., Suwon-si (KR)

(21) Appl. No.: 12/982,260

(22) Filed: Dec. 30, 2010

(30) Foreign Application Priority Data
Jan. 12, 2010 (KR) 10-2010-0002750

(51) Int. Cl. G02B 27/26

(52) U.S. Cl. 359/465

(57) ABSTRACT

Three-dimensional (3D) glasses and a 3D display apparatus are provided. The 3D display apparatus includes a backlight unit comprising a first light source unit for irradiating a first spectrum of light and a second light source unit for irradiating a second spectrum of light. The apparatus includes a polarization switch for selectively converting the polarization of incident light, and for reducing eye fatigue by providing a plurality of view images to each eye using a pair of glasses that each have a color filter and a birefringent device.

### CROSS-REFERENCE TO RELATED APPLICATION(S)

This application claims the benefit of Korean Patent Application No. 10-2010-0002750, filed on Jan. 12, 2010, in the Korean Intellectual Property Office, the entire disclosure of which is incorporated herein by reference for all purposes.

### BACKGROUND

1. Field

The following description relates to a three-dimensional (3D) display apparatus, and more particularly, to a 3D display apparatus capable of reducing eye fatigue.

2. Description of the Related Art

In general, stereoscopic vision of the human eyes generates a three-dimensional (3D) image. The separation of human eyes by approximately 65 mm generates a binocular parallax that is a factor in generating a 3D effect. The 3D effect is created by separately showing different view images to both eyes. In order to create the 3D effect, images are captured using two cameras separated apart from each other by approximately the distance between a pair of eyes, and an image captured by a left camera is shown to only a left eye and an image captured by a right camera is shown to only a right eye.

3D image display apparatuses may use stereoscopic methods and autostereoscopic methods. The stereoscopic methods may include, for example, a polarization glass method, a shutter glass method, and the like, and the autostereoscopic methods may include, for example, a parallax barrier method, a lenticular method, an integral imaging method, a holography method, and the like.

The shutter glass method may include a liquid crystal shutter glass method for generating a 3D image using glasses having liquid crystal shutters, liquid crystal shutter glasses, and the like. In the liquid crystal shutter glass method, different images are separately shown to left and right eyes in frequency periods of approximately 60 Hz. A 3D image display apparatus using a liquid crystal shutter glass method alternately displays left and right images and alternately opens or closes left and right liquid crystal shutters in synchronization with the displayed left and right images.

In the polarization glass method, for example, as a left-eye glass transmits light of P polarization and a right-eye glass transmits light of S polarization, an image formed due to the light of the P polarization is displayed to a left eye and an image formed due to the light of the S polarization is displayed to a right eye, thereby displaying a 3D image.

However, when a 3D image is viewed, eye fatigue may occur because the distance between a view and a screen plane is different from the distance between the viewer and a recognized position of the 3D image.

### SUMMARY

In one general aspect, there is provided a three-dimensional (3D) display apparatus comprising a backlight unit comprising a first light source unit for irradiating a first spectrum of light and a second light source unit for irradiating a second spectrum of light, a display panel for displaying an image using light irradiated from the backlight unit, a polarization switch for selectively converting the polarization of light transmitted from the display panel, a right-eye glass comprising a first color filter for transmitting the first spectrum of light and a first birefringent device having a variable refractive index based on the polarization of incident light, and a left-eye glass comprising a second color filter for transmitting the second spectrum of light and a second birefringent device having a variable refractive index based on the polarization of incident light.

The first spectrum of light and the second spectrum of light may not overlap each other.

The first light source unit and second light source unit may irradiate white light of different spectrums.

The first light source unit may comprise a first light source for irradiating a first wavelength of light, a second light source for irradiating a second wavelength of light, and a third light source for irradiating a third wavelength of light, and the second light source unit may comprise a fourth light source for irradiating a fourth wavelength of light, a fifth light source for irradiating a fifth wavelength of light, and a sixth light source for irradiating a sixth wavelength of light.

The first birefringent device may comprise a first birefringent material layer having first and second refractive indices based on the polarization of incident light, and a first material layer having a refractive index that is the same as the first or second refractive index, wherein the second birefringent device may comprise a second birefringent material layer having third and fourth refractive indices based on the polarization of incident light, and a second material layer having a refractive index that is the same as the third or fourth refractive index.

The first birefringent device may comprise a first birefringent material layer having first and second refractive indices based on the polarization of incident light, and first material layers may be disposed previously and subsequently to the first birefringent material layer and may have a refractive index that is the same as the first or second refractive index, wherein the second birefringent device may comprise a second birefringent material layer having third and fourth refractive indices based on the polarization of incident light, and second material layers may be disposed previously and subsequently to the second birefringent material layer and may have a refractive index that is the same as the third or fourth refractive index.

The left-eye glass may sequentially provide two or more view images to a left eye.

The right-eye glass may sequentially provides two or more view images to a right eye.

In another aspect, there is provided a three-dimensional (3D) glasses comprising a right-eye glass comprising a first color filter for transmitting a first spectrum of light and a first birefringent device having a variable refractive index based on the polarization of the first spectrum of light transmitted through the first color filter, and a left-eye glass comprising a second color filter for transmitting a second spectrum of light and a second birefringent device having a variable refractive index based on the polarization of the second spectrum of light transmitted through the second color filter.

The first spectrum of light and the second spectrum of light may not overlap each other.

The first birefringent device may comprise a first birefringent material layer having first and second refractive indices based on the polarization of incident light, and a first material layer having a refractive index that is the same as the first or second refractive index, wherein the second birefringent device may comprise a second birefringent material layer having third and fourth refractive indices based on the polarization of incident light, and a second material layer having a refractive index that is the same as the third or fourth refractive index.

The first birefringent device may comprise a first birefringent material layer having first and second refractive indices based on the polarization of incident light, and first material layers may be disposed previously and subsequently to the first birefringent material layer and may have a refractive index that is the same as the first or second refractive index, and wherein the second birefringent device may comprise a second birefringent material layer having third and fourth refractive indices based on the polarization of incident light, and second material layers may be disposed previously and subsequently to the second birefringent material layer and may have a refractive index that is the same as the third or fourth refractive index.

The left-eye glass may sequentially provide two or more view images to a left eye.

The right-eye glass may sequentially provide two or more view images to a right eye.

Other features and aspects may be apparent from the following description, the drawings, and the claims.

### BRIEF DESCRIPTION OF THE DRAWINGS

FIG. 1 is a diagram illustrating an example of a three-dimensional (3D) display apparatus.

FIG. 2 is a diagram illustrating an example of a backlight unit of a 3D display apparatus.

FIG. 3 is a graph illustrating examples of spectrums of light irradiated from the backlight unit of a 3D display apparatus.

FIG. 4A is a graph illustrating an example of a spectrum of light transmitted through a color filter of a 3D display apparatus.

FIG. 4B is a graph illustrating an example of a spectrum of light transmitted through a left-eye glass of a 3D display apparatus.

FIG. 4C is a graph illustrating an example of a spectrum of light transmitted through a right-eye glass of a 3D display apparatus.

FIG. 5 is a diagram illustrating an example of an eye glass of a 3D display apparatus.

FIG. 6 is a diagram illustrating an example of a 3D image that is formed using two view images.

Throughout the drawings and the description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

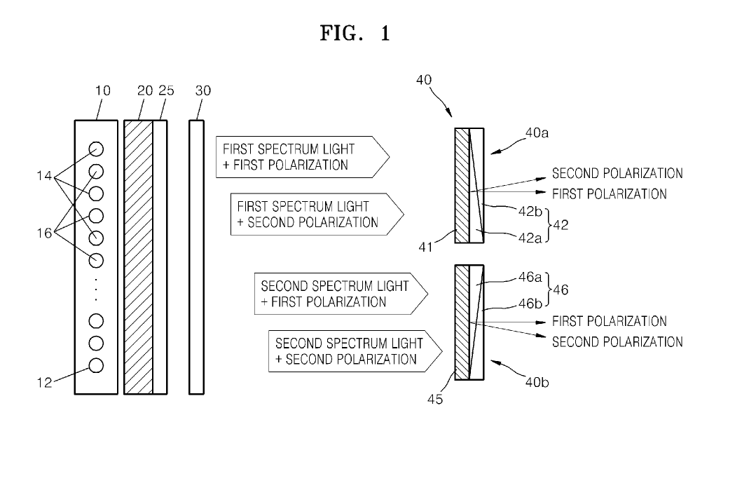

FIG. 1 illustrates an example of a three-dimensional (3D) display apparatus. Referring to FIG. 1, the 3D display apparatus includes a backlight unit 10 for irradiating light and a display device 20 for displaying an image using the light irradiated from the backlight unit 10.

The backlight unit 10 may include a plurality of light sources 12. The backlight unit 10 may be, for example, a direct light type, an edge light type, and the like, according to arrangement of the light sources 12. For a direct light type, the backlight unit 10 may directly irradiate light onto the display device 20 by disposing the light sources 12 under the display device 20. For the edge light type, the backlight unit 10 may irradiate light onto the display device 20 through a light guide plate (not shown). The 3D display apparatus, according to various embodiments, may be applied to any one of the direct light type and the edge light type. FIG. 1 illustrates an example of the direct light type of backlight unit 10. The light sources 12 may be, for example, light emitting diodes (LEDs), organic light emitting diodes (OLEDs), cold cathode fluorescent lamps (CCFLs), and the like.

The backlight unit 10 may include a first light source unit 14 for irradiating a first spectrum of light and a second light source unit 16 for irradiating a second spectrum of light.

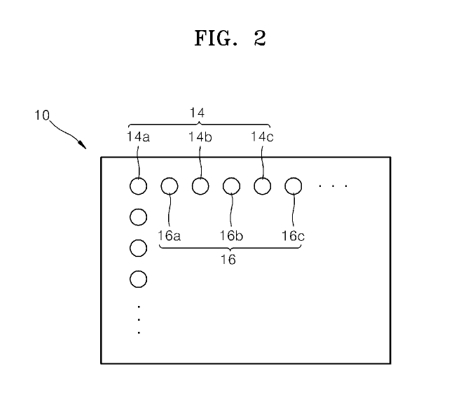

As illustrated in FIG. 2, the first and second light source units 14 and 16 may be two-dimensionally changed and alternately arranged. In some embodiments, the first spectrum of light and the second spectrum of light do not overlap each other.

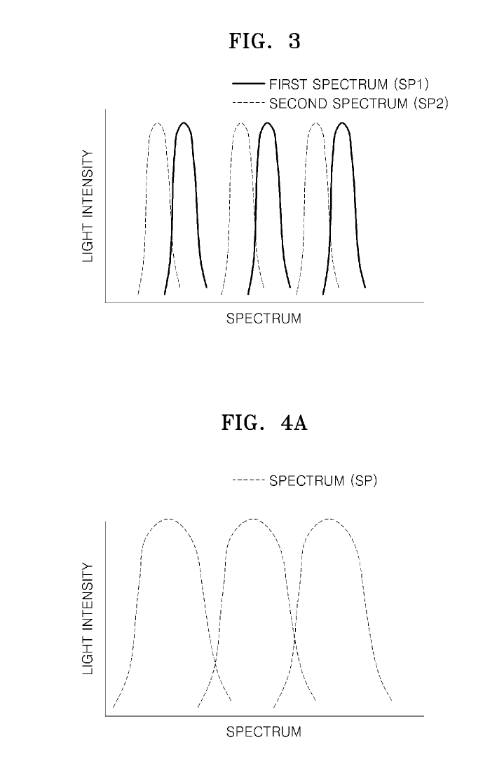

FIG. 3 illustrates an example of distributions of a first spectrum SP1 and a second spectrum SP2. For example, the first spectrum SP1 may include a first wavelength of light, a second wavelength of light, and a third wavelength of light, and the second spectrum SP2 may include a fourth wavelength of light, a fifth wavelength of light, and a sixth wavelength of light. In order to irradiate a first spectrum of light, the first light source unit 14 may include light sources for irradiating white light including the first spectrum light. In order to irradiate a second spectrum of light, the second light source unit 16 may include light sources for irradiating white light including the second spectrum light.

Alternatively, the first light source unit 14 may include color light sources for irradiating a wavelength of light included in the first spectrum. As illustrated in FIG. 2, the first light source unit 14 may include a first light source 14a for irradiating a first wavelength of light, a second light source 14b for irradiating a second wavelength of light, and a third light source 14c for irradiating a third wavelength of light. For example, the first light source 14a may irradiate a first red light, the second light source 14b may irradiate a first green light, and the third light source 14c may irradiate a first blue light.

The second light source unit 16 may include color light sources for irradiating a wavelength of light included in the second spectrum. The second light source unit 16 may include a fourth light source 16a for irradiating a fourth wavelength of light, a fifth light source 16b for irradiating a fifth wavelength of light, and a sixth light source 16c for irradiating a sixth wavelength of light. For example, the fourth light source 16a may irradiate a second red light, the fifth light source 16b may irradiate a second green light, and the sixth light source 16c may irradiate a second blue light. The first red light, the second red light, the first green light, the second green light, the first blue light and the second blue light may have different wavelengths, respectively.

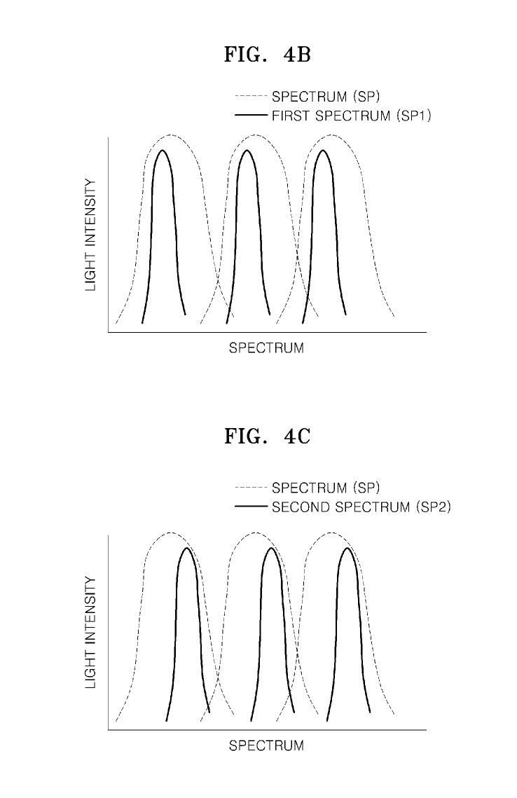

Referring again to FIG. 1, the display device 20 may include, for example, a liquid crystal display (LCD) device, a ferro liquid crystal display (FLCD) device, and the like. An LCD device may include a thin film transistor and an electrode in each pixel and may display an image by applying an electric field to the liquid crystals. The display device 20 may form an image by adjusting light transmittance in each pixel. The display device may include a color filter 25 to turn the image formed by the display device 20 into a color image. The color filter 25 may transmit light of a predetermined wavelength bandwidth. The color filter 25 may transmit the entire light irradiated from the first and second light source units 14 and 16. For example, FIG. 4A illustrates an example of a spectrum SP of light transmitted through the color filter 25. Referring to FIGS. 4B and 4C, the spectrum SP of light transmitted through the color filter 25 may include a first spectrum SP1 from the first light source unit 14 and a second spectrum SP2 from the second light source unit 16.

The display device may include a polarization switch 30 for converting the polarization of incident light. The polarization switch 30 may be disposed next to the display device 20. The polarization switch 30 may be, for example, a liquid crystal polarization switch. The polarization switch may convert the polarization of the incident light by selectively applying a voltage. For example, the polarization switch 30 may maintain an original polarization or convert an S polarization into a P polarization, or vice versa, according to a voltage signal by using twisted nematic (TN) liquid crystals.

The 3D display apparatus illustrated in FIG. 1 includes glasses 40 for separately transmitting the image formed by the display device 20 to left and right eyes. The glasses 40 may include a left-eye glass 40a and a right-eye glass 40b. The left-eye glass 40a may include a first color filter 41 and a first birefringent device 42. The right-eye glass 40b may include a second color filter 45 and a second birefringent device 46. The first color filter 41 may transmit the first spectrum of light that is irradiated from the first light source unit 14, and the second color filter 45 may transmit the second spectrum of light that is irradiated from the second light source unit 16.

The first and second color filters 41 and 45 display a 3D image by transmitting the image to the left and right eyes, respectively. The first and second birefringent devices 42 and 46 may have a variable refractive index according to the polarization of incident light. For example, the first and second birefringent devices 42 and 46 may have normal and abnormal refractive indices according to the polarization of incident light. A normal ray of light having a polarization parallel to a crystalline optical axis of the first and second birefringent devices 42 and 46 may be transmitted according to the normal refractive index of the first and second birefringent devices 42 and 46, without being refracted. An abnormal ray of light having a polarization perpendicular to the crystalline optical axis of the first and second birefringent devices 42 and 46 may be refracted according to the abnormal refractive index of the first and second birefringent devices 42 and 46. The first and second birefringent device 42 and 46 may be formed of, for example, calcite, liquid crystals, and the like.

The first birefringent device 42 may include a first birefringent material layer 42a that has first and second refractive indices according to the polarization of incident light, and a first material layer 42b that has a refractive index that is the same as the first or second refractive index. For example, the first birefringent material layer 42a may have a cross section of a right-angled triangle and the first material layer 42b may have a cross section of a right-angled inverted triangle.

The second birefringent device 46 may include a second birefringent material layer 46a that has third and fourth refractive indices according to the polarization of incident light, and a second material layer 46b that has a refractive index that is the same as the third or fourth refractive index. The first and second birefringent material layers 41a and 46a may be formed of substantially the same material. According to various embodiments, the second birefringent material layer 46a may have a cross section of a right-angled triangle and the second material layer 46b may have a cross section of a right-angled inverted triangle. However, the cross-sectional shapes and the arrangement orders of the first and second birefringent material layers 42a and 46a and the first and second material layers 42b and 46b are not limited thereto.

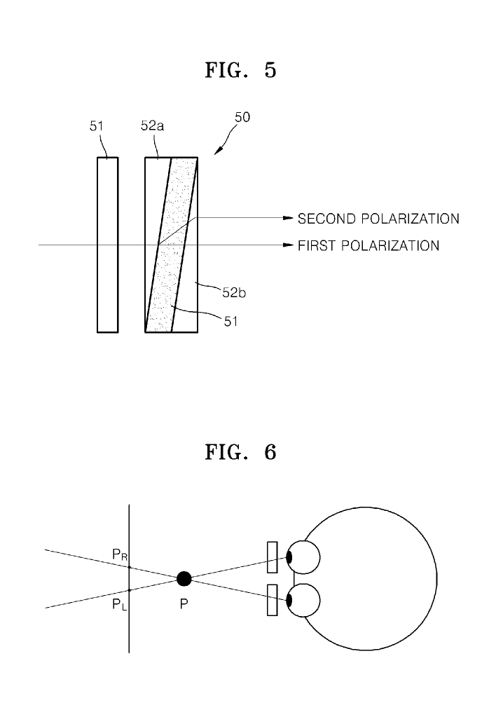

FIG. 5 illustrates an example of a birefringent device. The birefringent device 50 may be applied to a left eye glass and a right eye glass. The birefringent device 50 may include a birefringent material layer 51 that has first and second refractive indices according to the polarization of incident light, and first and second material layers 52a and 52b disposed previously and subsequently to the birefringent material layer 51. The first and second material layers 52a and 52b may have a refractive index that is the same as the first or second refractive index. The birefringent material layer 51 may have a cross section of a parallelogram and the first and second material layers 52a and 52b may have a cross section of a right-angled triangle. For example, the birefringent device 50 may have an overall cross section of a quadrangle. A color filter 51 may be included previously to the birefringent device 50 in a light proceeding direction. The color filter 51 may be separate and apart from the birefringent device 50 or combined with the birefringent device 50.

Operation of the 3D display apparatus illustrated in FIG. 1 is further described below.

Referring to FIG. 1, the first light source unit 14 of the backlight unit 10 irradiates a first spectrum light and the display device 20 forms an image using the first spectrum light. The display device 20 represents a grayscale by adjusting light transmittance in each pixel. A first color image may be formed as the color filter 25 selectively transmits color light. For example, the first color image may have a first polarization when passing through the polarization switch 30. The first color image includes light irradiated from the first light source unit 14 and thus has a first spectrum. The first color image is transmitted through the first color filter 41 and is blocked by the second color filter 45. Accordingly, the first color image is transmitted through the first color filter 41 and is incident onto only the first birefringent device 42.

The first birefringent device 42 may transmit light of a first polarization and may refract light of a second polarization. In some embodiments, the first polarization may be perpendicular to the second polarization. For example, the first polarization may include P polarization and the second polarization may include S polarization. Accordingly, the first birefringent device 42 may transmit the first color image formed due to the first spectrum light of the first polarization, without refraction.

The first spectrum of light may be irradiated from the first light source unit 14 and a second color image may be formed by the display device 20 and the color filter 25. The second color image may be incident onto the polarization switch 30 and the polarization switch 30 may convert the polarization of the second color image into the second polarization. The first birefringent device 42 may refractively transmit the second color image formed due to the first spectrum of light of the second polarization. As such, the first and second color images may be displayed as different view images and a left eye may view two view images. The first and second color images may be the same images or they may be different images.

If the first light source unit 14 is turned off, and the second light source unit 16 is turned on, the display device 20 and the color filter 25 may form a third color image using a second spectrum of light irradiated from the second light source unit 16. The third color image may have the first polarization when passing through the polarization switch 30. The third color image includes light irradiated from the second light source unit 16 and thus has a second spectrum, and is therefore blocked by the first color filter 41 and is transmitted only through the second color filter 45. Accordingly, the third color image that has the first polarization is transmitted through the second color filter 45 and is incident onto only the second birefringent device 46. The second birefringent device 46 may transmit the third color image formed due to the second spectrum light of the first polarization, without refraction.

The second spectrum of light may be irradiated from the second light source unit 16 and a fourth color image may be formed by the display device 20 and the color filter 25. The fourth color image may be incident onto the polarization switch 30 and the polarization switch 30 may convert the polarization of the fourth color image into the second polarization. The second birefringent device 46 may refract and transmit the fourth color image formed due to the second spectrum light of the second polarization. Accordingly, the third and fourth color images may be displayed as different view images and a right eye may view two view images. The third and fourth color images may be the same images or they may be different images.

As described above, because two or more view images are viewed to each of left and right eyes, eye fatigue normally experienced while viewing a 3D image may be reduced. FIG. 6 illustrates an example of a 3D image that is formed using two view images. Image display positions P_{L} and P_{R} of a display apparatus are different from a 3D image display position P recognized by a viewer and thus eye fatigue is increased. In other words, images displayed by the display apparatus are displayed on the two positions P_{L} and P_{R} on a screen plane and thus the viewer focuses eye lenses on the screen plane. Because the focus position P where the 3D image is formed due to a stereo pair is different from the screen plane, eye fatigue may be increased due to the difference in depth between the screen plane and the focus position P.

However, if the number of view images to be viewed by one eye is increased, the difference between the focus positions on a screen plane where images are displayed and a focal position recognized by the eyes may be reduced and thus eye fatigue may be reduced.

In comparison to the two view image display for viewing one view image to one eye, a focal position in multi-view image display is closer to an actual focal position of a target object. When an actual focal position of a target object is close to a focal position recognized by a human, eye fatigue may be reduced.

Accordingly, the 3D display apparatus illustrated in FIG. 1 may reduce eye fatigue when a 3D image is viewed, by reducing the distance between view images such that two or more view images are viewed by an eye. For example, a left-eye glass may sequentially provide two or more view images to a left eye and a right-eye glass may sequentially provide two or more view images to a right eye.

Meanwhile, as the first and second birefringent devices 42 and 46 illustrated in FIG. 1 transmit light of a first polarization and refract light of a second polarization, the light of the second polarization may have a varied incident angle onto the eyes in comparison to the light of the first polarization. As the birefringent device 50 illustrated in FIG. 5 transmits light of a first polarization, and light of a second polarization is refracted by the birefringent material layer 51 and then is refracted again by the second material layer 52b, the light of the second polarization has an unvaried incident angle onto the eyes with a varied relative position in comparison to the light of the first polarization. As two different view images are viewed using the above-described different characteristics, various view images may be displayed.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A three-dimensional (3D) display apparatus comprising:
a backlight unit comprising a first light source unit for irradiating a first spectrum of light and a second light source unit for irradiating a second spectrum of light;
a display panel for displaying an image using light irradiated from the backlight unit;
a polarization switch for selectively converting the polarization of light transmitted from the display panel;
a right-eye glass comprising a first color filter for transmitting the first spectrum of light and a first birefringent device having a variable refractive index based on the polarization of incident light; and
a left-eye glass comprising a second color filter for transmitting the second spectrum of light and a second birefringent device having a variable refractive index based on the polarization of incident light.

2. The apparatus of claim 1, wherein the first spectrum of light and the second spectrum of light do not overlap each other.

3. The apparatus of claim 1, wherein the first light source unit and second light source unit irradiate white light of different spectrums.

4. The apparatus of claim 1, wherein the first light source unit comprises a first light source for irradiating a first wavelength of light, a second light source for irradiating a second wavelength of light, and a third light source for irradiating a third wavelength of light, and the second light source unit comprises a fourth light source for irradiating a fourth wavelength of light, a fifth light source for irradiating a fifth wavelength of light, and a sixth light source for irradiating a sixth wavelength of light.

5. The apparatus of claim 1, wherein the first birefringent device comprises:
a first birefringent material layer having first and second refractive indices based on the polarization of incident light; and
a first material layer having a refractive index that is the same as the first or second refractive index,
wherein the second birefringent device comprises:
a second birefringent material layer having third and fourth refractive indices based on the polarization of incident light; and
a second material layer having a refractive index that is the same as the third or fourth refractive index.

6. The apparatus of claim 1, wherein the first birefringent device comprises:
a first birefringent material layer having first and second refractive indices based on the polarization of incident light; and
first material layers disposed previously and subsequently to the first birefringent material layer and having a refractive index that is the same as the first or second refractive index,
wherein the second birefringent device comprises:
a second birefringent material layer having third and fourth refractive indices based on the polarization of incident light; and
second material layers disposed previously and subsequently to the second birefringent material layer and having a refractive index that is the same as the third or fourth refractive index.

7. The apparatus of claim 1, wherein the left-eye glass sequentially provides two or more view images to a left eye.

8. The apparatus of claim 7, wherein the right-eye glass sequentially provides two or more view images to a right eye.

9. Three-dimensional (3D) glasses comprising:
a right-eye glass comprising a first color filter for transmitting a first spectrum of light and a first birefringent device having a variable refractive index based on the polarization of the first spectrum of light transmitted through the first color filter; and
a left-eye glass comprising a second color filter for transmitting a second spectrum of light and a second birefringent device having a variable refractive index based on the polarization of the second spectrum of light transmitted through the second color filter.

10. The glasses of claim 9, wherein the first spectrum of light and the second spectrum of light do not overlap each other.

11. The glasses of claim 9, wherein the first birefringent device comprises:
a first birefringent material layer having first and second refractive indices based on the polarization of incident light; and
a first material layer having a refractive index that is the same as the first or second refractive index,
wherein the second birefringent device comprises:
a second birefringent material layer having third and fourth refractive indices based on the polarization of incident light; and
a second material layer having a refractive index that is the same as the third or fourth refractive index.

12. The glasses of claim 9, wherein the first birefringent device comprises:
a first birefringent material layer having first and second refractive indices based on the polarization of incident light; and
first material layers disposed previously and subsequently to the first birefringent material layer and having a refractive index that is the same as the first or second refractive index, and
wherein the second birefringent device comprises:
a second birefringent material layer having third and fourth refractive indices based on the polarization of incident light; and
second material layers disposed previously and subsequently to the second birefringent material layer and having a refractive index that is the same as the third or fourth refractive index.

13. The glasses of claim 9, wherein the left-eye glass sequentially provides two or more view images to a left eye.

14. The glasses of claim 13, wherein the right-eye glass sequentially provides two or more view images to a right eye.
